(19) United States
(12) Patent Application Publication
(10) Pub. No.: US 2016/0002013 A1
(43) Pub. Date: Jan. 7, 2016

(54) Tether Winding

(71) Applicant: Google Inc., Mountain View, CA (US)

(72) Inventors: Brian Hachtmann, San Martin, CA (US); Damon Vander Lind, Alameda, CA (US)

(21) Appl. No.: 14/588,105

(22) Filed: Dec. 31, 2014

Related U.S. Application Data
(60) Provisional application No. 62/021,516, filed on Jul. 7, 2014.

(51) Int. Cl. B66D 1/38; B66D 1/60

(52) U.S. Cl. CPC B66D 1/38; B66D 1/60

(57) ABSTRACT

Wind energy systems, such as an Airborne Wind Turbine (“AWT”), may be used to facilitate conversion of kinetic energy to electrical energy. An AWT may include an aerial vehicle that flies in a path, such as a substantially circular path, to convert kinetic wind energy to electrical energy. In an example embodiment, the aerial vehicle may be connected to a ground station via a tether that both restrains the AWT and conveys the electrical energy to the base station. The tether may be wound about a drum when the AWT is not in flight, and the drum may include a helical groove of varying pitch to receive the tether. An asymmetrical levelwind may be positioned adjacent to the drum and configured to move along the drum and guide the tether onto the drum.

### RELATED APPLICATION

This application claims the benefit of priority from U.S. Provisional Application No. 62/021,516 filed Jul. 7, 2014, the disclosure of which is explicitly incorporated by reference herein in its entirety.

### BACKGROUND

Unless otherwise indicated herein, the materials described in this section are not prior art to the claims in this application and are not admitted to be prior art by inclusion in this section.

Power generation systems may convert chemical and/or mechanical energy (e.g., kinetic energy) to electrical energy for various applications, such as utility systems. As one example, a wind energy system may convert kinetic wind energy to electrical energy.

The use of wind turbines as a means for harnessing energy has been used for a number of years. Conventional wind turbines typically include large turbine blades positioned atop a tower. The cost of manufacturing, erecting, maintaining, and servicing such wind turbine towers, and wind turbines is significant.

An alternative to the costly wind turbine towers that may be used to harness wind energy is to use an aerial vehicle attached to a ground station with an electrically conductive tether. Such an alternative may be referred to as an Airborne Wind Turbine (AWT).

### SUMMARY

The present disclosure generally relates to systems and methods that incorporate a ground station for tethering aerial vehicles such as those employed in crosswind aerial vehicle systems. Crosswind aerial vehicle systems may extract useful power from the wind for various purposes such as, for example, generating electricity, lifting or towing objects or vehicles, etc. Deploying, retrieving, and storing the aerial vehicle may present difficulties due to, for example, the physical characteristics of the tether connecting the aerial vehicle to the ground station. Beneficially, embodiments described herein may allow for more reliable, safe, and efficient deployment, retrieval, and storage of aerial vehicles and the associated tether. These as well as other aspects, advantages, and alternatives will become apparent to those of ordinary skill in the art by reading the following detailed description, with reference where appropriate to the accompanying drawings.

In one aspect, a levelwind apparatus is provided. The levelwind apparatus may have a rotational axis, a first edge with a first diameter, and a second edge with a second diameter. The first and second edges may be concentric about the rotational axis; and a guiding surface may be located between the first and second edges. The guiding surface may have a guide groove perpendicular to the rotational axis and sized to receive a tether. The perpendicular distance from the first edge to the guide groove may be greater than the perpendicular distance from the second edge to the guide groove.

In another aspect, a system is provided. The system may include a drum with a first rotational axis and a substantially cylindrical drum surface. The drum surface may include a helical groove sized to receive a tether, and the helical groove may have a pitch relative to the rotational axis. The pitch of the helical groove may vary about the drum surface. The drum may also include a motor mechanically coupled to the drum for rotating the drum about the first rotational axis. The system may also include a levelwind with a second rotational axis, a first edge with a first diameter, and a second edge with a second diameter. The first and second edges may be concentric about the second rotational axis and a guiding surface may be located between the first and second edges. The guiding surface may have a guide groove perpendicular to the second rotational axis and sized to receive a tether. The perpendicular distance from the first edge to the guide groove may be greater than the perpendicular distance from the second edge to the guide groove. The system may also include a linear actuator mechanically coupled to the motor and configured to position the levelwind along the second rotational axis such that the guiding surface remains in substantial alignment with the helical groove on the drum surface as the drum rotates about the first rotational axis.

In another aspect, a method of winding a tether about a drum is provided. The method may include the step of rotating the drum about a first rotational axis. The drum may have a rotational axis and a substantially cylindrical drum surface. The drum surface may include a helical groove sized to receive a tether, and the helical groove may have a pitch relative to the rotational axis. The pitch of the helical groove may vary about the drum surface. The method may also include the step of positioning a levelwind with a guiding surface along a second rotational axis at a constant rate such that a guiding surface remains in substantial alignment with the helical groove on the drum surface as the drum rotates about the first rotational axis. The levelwind may include the second rotational axis, a first edge with a first diameter, and a second edge with a second diameter. The first and second edges may be concentric about the second rotational axis and the guiding surface may be located between the first and second edges. The guiding surface may have a guide groove perpendicular to the second rotational axis and sized to receive a tether. The perpendicular distance from the first edge to the guide groove may be greater than the perpendicular distance from the second edge to the guide groove.

### BRIEF DESCRIPTION OF THE DRAWINGS

FIG. 1 is a perspective view of an airborne wind turbine 10 including aerial vehicle 20 attached to a ground station 50 with an electrically conductive tether 30, according to an example embodiment.

FIG. 2 is a close-up perspective view of aerial vehicle 20 shown in FIG. 1.

FIG. 3 is a cross-sectional view of the electrically conductive tether 30 shown in FIG. 1.

FIG. 4 is a side view of an example drum and levelwind configuration.

FIG. 5 is a side view of a levelwind 160 according to an example embodiment.

FIG. 6A is a side view of a ground station 150 having a drum 180 and levelwind 160 while an aerial vehicle 120 is in flight, according to an example embodiment.

FIG. 6B is a top view of the ground station 150 shown in FIG. 6A, according to an example embodiment.

FIG. 7A is a side view of the ground station 150 while the aerial vehicle 120 is landing and a tether 130 is being wound about a drum 180 using levelwind 160, according to an example embodiment.

FIG. 7B is a top view of the ground station 150 shown in FIG. 7A, according to an example embodiment.

FIG. 7C is a side view of the levelwind 160 and the tether 130 shown in FIG. 7A.

FIG. 8A is a side view of the tether 130 fully wound about the drum 180, with aerial vehicle 120 perched on a perch panel 176 attached to the ground station 150, according to an example embodiment.

FIG. 8B is a top view of the aerial vehicle 120 and ground station 150 shown in FIG. 8A, according to an example embodiment.

### DETAILED DESCRIPTION

Example apparatuses, systems and methods are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein and illustrated in the Figures, can be arranged, substituted, combined, separated, and designed in a wide variety of different configurations, all of which are contemplated herein. Further, unless otherwise noted, Figures are not drawn to scale and are used for illustrative purposes only. Moreover, the Figures are representational only and not all components are shown. For example, additional structural or restraining components may not be shown.

### I. OVERVIEW

Example embodiments relate to aerial vehicles, which may be used in a wind energy system, such as an Airborne Wind Turbine (AWT). In particular, example embodiments may relate to or take the form of apparatuses, systems, and methods for using an aerial vehicle that is attached to a ground station using an electrically conductive tether.

By way of background, an AWT may include an aerial vehicle that flies in a path, such as a substantially circular path, to convert kinetic wind energy to electrical energy via onboard turbines. In an example embodiment, the aerial vehicle may be connected to a ground station via a tether. While tethered, the aerial vehicle may: (i) fly at a range of elevations and substantially along the path, and return to the ground, and (ii) transmit electrical energy to the ground station via the tether. In some embodiments, the ground station may transmit electricity to the aerial vehicle via the tether for take-off and/or landing.

In an AWT, an aerial vehicle may rest in and/or on a ground station when the wind is not conducive to power generation. When the wind is conducive to power generation, such as when a wind speed may be 10 meters per second (m/s) at an altitude of 200 meters (m), the ground station may deploy (or launch) the aerial vehicle. Further, if the aerial vehicle is deployed but the wind is not conducive to power generation, the aerial vehicle may return to the ground station.

An aerial vehicle in an AWT may be configured for hover flight and cross-wind flight. Cross-wind flight may be used to travel in a motion, such as a substantially circular motion, and may be the primary technique that is used to generate electrical energy. Hover flight may be used by the aerial vehicle to prepare and position itself for crosswind flight. In particular, the aerial vehicle may ascend to a location for crosswind flight based at least in part on hover flight. Further, the aerial vehicle could take-off and/or land via hover flight.

In hover flight, a span of a main wing of the aerial vehicle may be oriented substantially parallel to the ground, and one or more propellers of the aerial vehicle may cause the aerial vehicle to hover over the ground. In some embodiments, the aerial vehicle may vertically ascend or descend in hover flight.

In cross-wind flight, the aerial vehicle may fly across the wind in a circular pattern similar to the tip of a large bladed wind turbine. The rotors attached to the rigid wing may be used to generate power by slowing the wing down. In particular, air moving across the turbine blades may force the blades to rotate, driving a generator to produce electricity. The aerial vehicle may also be connected to a ground station via an electrically conductive tether that transmits power generated by the aerial vehicle to the ground station. The generated power may be stored, transmitted to the grid, used locally, or put to some other purpose.

The aerial vehicle may enter crosswind flight when (i) the aerial vehicle has attached wind-flow (e.g., steady flow and/or no stall condition (which may refer to no separation of air flow from an airfoil)) and (ii) the tether is under tension. Moreover, the aerial vehicle may enter crosswind flight at a location that is substantially downwind of the ground station.

When it is desired to land the aerial vehicle, the electrically conductive tether may be wound onto a spool or drum in the ground station, which reels in the aerial vehicle towards a perch on the ground station. Prior to landing on the perch, the aerial vehicle may transition from a flying mode to a hover mode. After the aerial vehicle transitions to hover mode, the tether may be wound onto the drum until the aerial vehicle comes to rest on the perch.

The electrically conductive tether may be constructed of a carbon fiber core surrounded by aluminum conductors. The carbon fiber core and aluminum conductors may be positioned within an outer insulation. As noted above, the tether transmits electricity from the aerial vehicle to the ground station through the aluminum conductors, and care must be taken to protect the tether. In an embodiment, the tether has a length of 500 meters, which must be carefully wound onto the drum, without crushing or damaging the tether. The tether tends to be very strong in tension, but fragile in storage as the insulation and wire can be compressed. Therefore it may be desirable to provide a drum surface that reduces the stress concentration of point loads and thereby protects the tether as it is wound onto the drum.

In the disclosed exemplary embodiments, the drum may be either vertical or horizontal (or combination thereof) and is capable of winding the tether onto the drum with a desired spacing between successive lengths of the tether. Furthermore, particularly in the case of a vertical drum, the disclosed exemplary embodiments provide a drum surface that serves to prevent the tether from “slipping” down the surface of the drum and maintains the desired spacing between the successive lengths of the tether as the tether is stored on the drum. In some embodiments, the tether may be on the order of 500 meters in length, although shorter or longer tethers may be used as well. The tether is wound onto the drum without winding successive lengths of tether onto one another (unlike a fishing reel where the line is wrapped over itself). As a result, the drum may need to be quite large to accommodate the entire length and weight of the tether. For example, the drum may be 3.5 meters in diameter in some configurations.

In an example embodiment, a substantially cylindrical drum is provided. The drum's surface may incorporate a helical groove sized to receive the tether. The groove may allow the tether to lie on the drum such that the tether does not experience an excessive pressure concentration at the point of contact between the tether and the surface of the drum. Rather, the drum surface may have a cross-section with grooves that conform to, and cradle, the outer surface of the tether. Therefore, if the outer surface of the tether is round, then the drum surface may have grooves with a corresponding round shape in which the tether will rest. Similarly, if the surface of the tether is oval, and more aerodynamic, the corresponding surface of the drum may be formed to match the oval surface of the tether. In some examples, the helical groove may maintain a constant pitch about the drum surface, thereby maintaining a constant spacing between each successive wrap of the tether as it is wound onto the drum.

When the aerial vehicle is in cross-wind flight, the pitch angle of the tether may vary from a few degrees below its connection point at the ground station to as high as 45 degrees above its connection point in some examples. However, when the aerial vehicle transitions to hover flight, descending while the tether is wound about the drum, the profile of the tether may be fairly approximated as a catenary between the aerial vehicle and ground station. Accordingly, for the majority of the aerial vehicle's descent, the pitch angle of the tether at the ground station may remain approximately horizontal. Nonetheless, wind turbulence and other factors may affect the position of both the aerial vehicle and the tether with respect to the drum as the drum is being wound.

Consequently, in some embodiments, a levelwind may be provided adjacent to the drum to guide the tether to a desired location on the drum surface as the drum is rotated. The levelwind may resemble a pulley with a central guide groove that may keep the tether aligned with the helical groove about the drum. The levelwind may further include rounded guide bars or other guidance structures which may sweep an area larger than the levelwind, and then bias the tether inward toward the levelwind's central guide groove.

As the example drum rotates, the tether will be wound into the helical groove and each successive wrap of the tether will be spaced an equal distance apart, provided the groove has a constant pitch. In the case of a vertical drum, the wrapped tether may slowly descend the drum surface of the drum as the drum it rotates. Similarly, the levelwind may also descend adjacent to the drum at the same rate, such that is remains in alignment with the desired groove location on the drum surface. To accomplish this, the levelwind may be coupled to a linear actuator. Further, if the pitch of the helical groove is constant, the linear movement of the levelwind may also be constant, and directly correlated to the rotation of the drum. Therefore, the linear actuator which controls the position of the levelwind may be geared to the same motor that rotates the drum.

However, in some embodiments, the groove in the drum surface may not have a constant pitch. Rather, the pitch of the helical groove may be varied in order to increase the spacing between wraps of the tether. In some cases, this may be desired to avoid conflicts with other components of the system. For example, in some embodiments, the tether may connect to the ground station via a ground-side gimbal (GSG). The GSG may allow for changes in pitch, roll, and yaw of the tether during cross-wind flight and thereby minimize bending and torsional forces on the tether at its connection point to the ground station. Because the GSG rotates in the tether's azimuth orientation, it may rotate to one side and “lay over” when the drum begins to wind in the tether. However, the GSG may be fairly large, and it may be located above the top edge of a vertically oriented drum, near its perimeter. Further, the GSG may include a spindle at the tether's connection point that constrains any bending for a portion of the tether. The spindle may provide increased leverage for the tether to more easily rotate the gimbal, further reducing stresses on the tether.

As a result, the size, location, and configuration of the GSG may result in a convergence issue when winding the tether about the drum. For instance, it may not be possible for the second wrap of the tether to be located only 25 millimeters below the tether's connection point at the GSG. The GSG may simply be too large, and get in the way of the tether if it is wrapped about the drum at a pitch of only 25 millimeters per rotation. Increasing the spacing of the tether across the entire drum may be inefficient, and result in a drum that is excessively large. Further, the end of the spindle, where the tether may first begin wrapping about the drum, may not be tangent to the drum surface when the GSG lays over.

Therefore, in some embodiments, the geometry of the drum surface may be varied. For example, for a section the drum, approximately the first three-quarters of a rotation from the top of the drum, the drum may be raised and the pitch of the helical groove may be increased from a typical pitch of 25 millimeters per rotation to 250 millimeters per rotation. This may allow the tether to be wound further down on the drum, away from the GSG, for the first rotation. Thereafter, on the second and subsequent rotations, the helical drum groove may have a constant pitch of 25 millimeters per rotation. Further, the same raised section of the drum may have a reduced radius measured from the drum's rotational axis. As a result, the raised section at the top of the drum with an increased groove pitch may also spiral inward toward the tether's connection point at the spindle when the GSG is lying over.

A levelwind as discussed above may be used with a drum having the described configuration. However, because the pitch of the helical groove on the drum surface is not constant, the levelwind may not descend adjacent to the drum at a constant rate in relation to the constant rotation of the drum. Instead, additional controls may be used to determine when the drum groove is increasing in pitch and then a variable speed drive may increase the rate at which the levelwind moves. This deterministic approach may keep the levelwind, and thus the incoming tether, aligned with the drum groove, even though the groove does not have a constant pitch.

Alternatively, a non-deterministic approach may be employed using a modified levelwind. In some embodiments, the levelwind may have an asymmetric geometry to accommodate the increased pitch in the drum groove at the beginning of the drum's rotation. The levelwind may include a first and second edge with a guiding surface in between the two edges. The guiding surface may include a guide groove sized to receive the tether, however the guide groove may not be centered in the guiding surface of the levelwind. Instead, the distance from the first edge to the guide groove may be greater than the distance from the second edge to the guide groove. This may allow the tether to make contact with the levelwind in this area of increased height on the guiding surface, between the first edge and the guide groove. The guiding surface of the levelwind may bias the tether downward as the levelwind rotates.

Additionally, for the raised drum section where the drum groove has an increased pitch, the additional height between drum grooves may also be configured to bias the tether into the drum groove. Therefore, as the pitch of the drum groove increases, the area of the raised drum section on which the levelwind can place the tether may also increase.

These embodiments may be referred to as non-deterministic winding, at least for the first three-quarters of a rotation where the tether is first wound onto the raised drum section, because the tether may not be transferred directly from the levelwind guide groove to the drum groove. Instead, the levelwind may receive the tether anywhere within the increased height of the levelwind's guiding surface, and the levelwind may then transfer the tether onto the drum surface within the similarly increased height between drum grooves.

Because of the correspondence between the asymmetric configuration of the levelwind and the raised drum section, a variable speed drive or additional controllers may not be needed to vary the rate at which the levelwind ascends or descends adjacent to the drum. In such embodiments, the drum may be mechanically coupled to a motor for rotating the drum about its rotational axis. Further, the levelwind may be positioned vertically on its rotational axis by a linear actuator that is geared to the same motor, as the two movements may maintain a constant relationship throughout the tether winding process. Specifically, the levelwind may be positioned such that the guide groove on the levelwind remains in substantial alignment with the drum groove for the majority of the drum's rotation where the drum groove has a constant pitch. For the raised drum section, where the drum groove has an increased pitch, the drum groove and the levelwind guide groove may not be aligned. However, the drum groove may nonetheless remain in substantial alignment with the full height of the levelwind's guiding surface.

The example embodiments above have generally described the winding in of the tether and the landing of the aerial vehicle. It should be readily understood that the same embodiments may be used in substantially the same way, although in reverse, for winding out the tether as the aerial vehicle ascends in hover flight.

### II. ILLUSTRATIVE SYSTEMS

A. Example Airborne Wind Turbine (AWT)

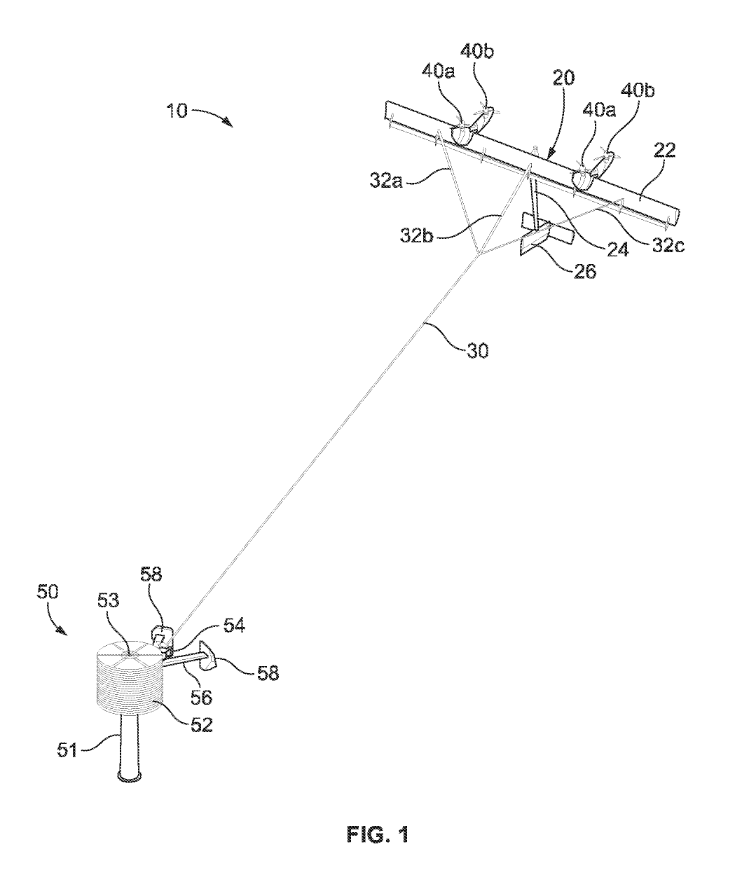

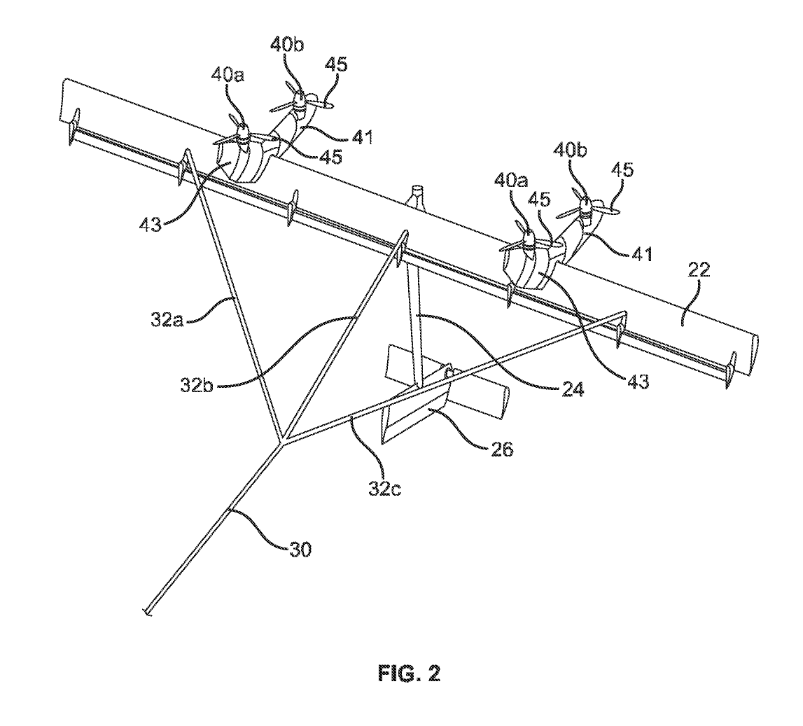

As disclosed in FIGS. 1-2, an airborne wind turbine (AWT) 10 is disclosed, according to an example embodiment. AWT 10 is a wind based energy generation device that includes an aerial vehicle 20 constructed of a rigid wing 22 with mounted turbines 40 that flies in a path, such as a substantially circular path, across the wind. In an example embodiment, the aerial vehicle may fly between 250 and 600 meters above the ground (or water) to convert kinetic wind energy to electrical energy. However, an aerial vehicle may fly at other heights without departing from the scope of the invention. In cross-wind flight, the aerial vehicle 20 flies across the wind in a circular pattern similar to the tip of a large bladed wind turbine. The rotors 40 attached to the rigid wing 22 are used to generate power by slowing the wing 22 down. Air moving across the turbine blades forces them to rotate, driving a generator to produce electricity. The aerial vehicle 20 is connected to a ground station 50 via an electrically conductive tether 30 that transmits power generated by the aerial vehicle to the ground station 50.

As shown in FIG. 1, the aerial vehicle 20 may be connected to the tether 30, and the tether 30 may be connected to the ground station 50. In this example, the tether 30 may be attached to the ground station 50 at one location on the ground station 50, and attached to the aerial vehicle 20 at three locations on the aerial vehicle 2 using bridal 32a, 32b, and 32c. However, in other examples, the tether 30 may be attached at multiple locations to any part of the ground station 50 and/or the aerial vehicle 20.

The ground station 50 may be used to support or store the aerial vehicle 20 until it is in an operational mode. The ground station may include a tower 51 that may be on the order of 15 meters tall. The ground station 50 may also include a drum 52 rotatable about drum axis 53 that is used to reel in aerial vehicle 20 by winding the tether 30 onto the rotatable drum 52. The ground station 50 may also include a levelwind (not shown in FIG. 1) to guide the tether 30 onto the drum 52 as it is wound. In this example, the drum 52 is oriented vertically, although the drum may also be oriented horizontally or at an angle. Further, the ground station 50 may be further configured to receive the aerial vehicle 20 during a landing. For example, support members 56 are attached to perch panels 58 that extend from the ground station 50. When the tether 30 is wound onto drum 52 and the aerial vehicle 20 is reeled in towards the ground station 50, the aerial vehicle may come to rest upon perch panels 58. The ground station 50 may be formed of any material that can suitably keep the aerial vehicle 20 attached and/or anchored to the ground while in hover flight, forward flight, or crosswind flight. In some implementations, ground station 50 may be configured for use on land. However, ground station 50 may also be implemented on a body of water, such as a lake, river, sea, or ocean. For example, a ground station could include or be arranged on a floating off-shore platform or a boat, among other possibilities. Further, ground station 50 may be configured to remain stationary or to move relative to the ground or the surface of a body of water.

The tether 30 may transmit electrical energy generated by the aerial vehicle 20 to the ground station 50. In addition, the tether 30 may transmit electricity from the ground station 50 to the aerial vehicle 20 in order to power the aerial vehicle 20 during takeoff, landing, hover flight, and/or forward flight. The tether 30 may be constructed in any form and using any material which may allow for the transmission, delivery, and/or harnessing of electrical energy generated by the aerial vehicle 20 and/or transmission of electricity to the aerial vehicle 20. The tether 30 may also be configured to withstand one or more forces of the aerial vehicle 20 when the aerial vehicle 20 is in an operational mode.

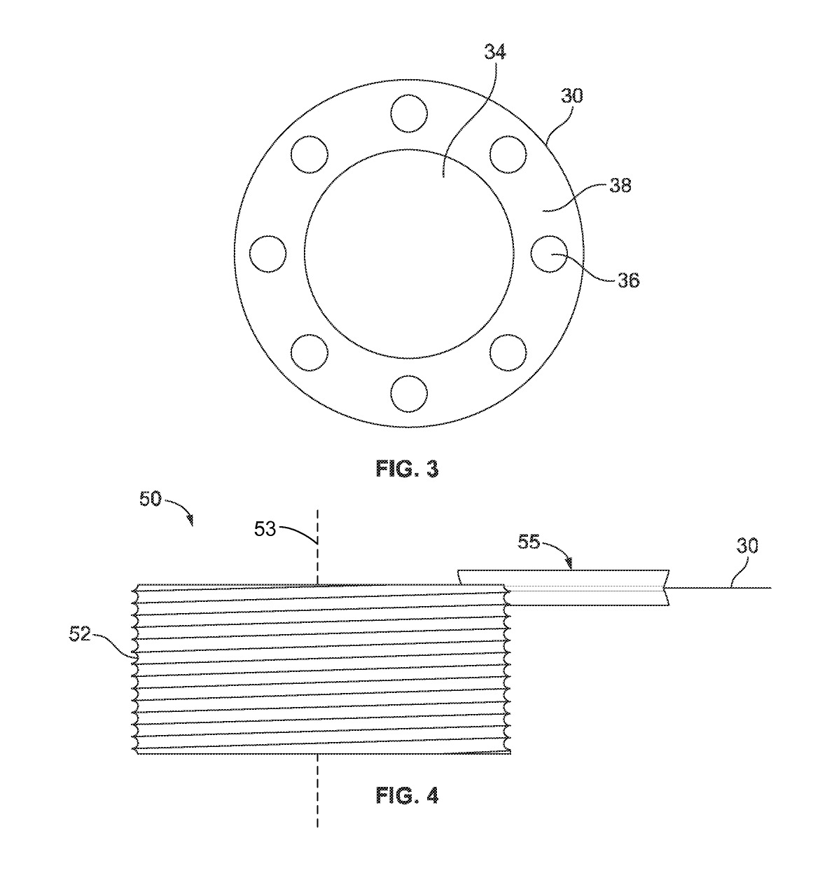

For example, as shown in FIG. 3, the tether 30 may include a core configured to withstand one or more forces of the aerial vehicle 20 when the aerial vehicle 20 is in hover flight, forward flight, and/or crosswind flight. The core may be constructed of any high strength fibers or a carbon fiber rod. In some examples, the tether 30 may have a fixed length and/or a variable length. For example, in one example, the tether has a fixed length of 500 meters.

The aerial vehicle 20 may include or take the form of various types of devices, such as a kite, a helicopter, a wing and/or an airplane, among other possibilities. The aerial vehicle 20 may be formed of solid structures of metal, plastic and/or other polymers. The aerial vehicle 20 may be formed of any material which allows for a high thrust-to-weight ratio and generation of electrical energy which may be used in utility applications. Additionally, the materials may be chosen to allow for a lightning hardened, redundant and/or fault tolerant design which may be capable of handling large and/or sudden shifts in wind speed and wind direction. Other materials may be possible as well.

As shown in FIG. 1, and in greater detail in FIG. 2, the aerial vehicle 20 may include a main wing 22, rotors 40a and 40b, tail boom or fuselage 24, and tail wing 26. Any of these components may be shaped in any form which allows for the use of components of lift to resist gravity and/or move the aerial vehicle 20 forward.

The main wing 22 may provide a primary lift for the aerial vehicle 20. The main wing 22 may be one or more rigid or flexible airfoils, and may include various control surfaces, such as winglets, flaps, rudders, elevators, etc. The control surfaces may be used to stabilize the aerial vehicle 20 and/or reduce drag on the aerial vehicle 20 during hover flight, forward flight, and/or crosswind flight. The main wing 22 may be any suitable material for the aerial vehicle 20 to engage in hover flight, forward flight, and/or crosswind flight. For example, the main wing 20 may include carbon fiber and/or e-glass.

Rotor connectors 43 may be used to connect the upper rotors 40a to the main wing 22, and rotor connectors 41 may be used to connect the lower rotors 40b to the main wing 22. In some examples, the rotor connectors 43 and 41 may take the form of or be similar in form to one or more pylons. In this example, the rotor connectors 43 and 41 are arranged such that the upper rotors 40a are positioned above the wing 22 and the lower rotors 40b are positioned below the wing 22.

The rotors 40a and 40b may be configured to drive one or more generators for the purpose of generating electrical energy. In this example, the rotors 40a and 40b may each include one or more blades 45, such as three blades. The one or more rotor blades 45 may rotate via interactions with the wind and which could be used to drive the one or more generators. In addition, the rotors 40a and 40b may also be configured to provide a thrust to the aerial vehicle 20 during flight. With this arrangement, the rotors 40a and 40b may function as one or more propulsion units, such as a propeller. Although the rotors 40a and 40b are depicted as four rotors in this example, in other examples the aerial vehicle 20 may include any number of rotors, such as less than four rotors or more than four rotors, e.g. six or eight rotors.

Referring back to FIG. 1, when it is desired to land the aerial vehicle 20, the drum 52 is rotated to reel in the aerial vehicle 20 towards the perch panels 58 on the ground station 50, and the electrically conductive tether 30 is wound onto drum 52. Prior to landing on the perch panels 58, the aerial vehicle 20 transitions from a flying mode to a hover mode. The drum 52 is further rotated to further wind the tether 30 onto the drum 52 until the aerial vehicle 20 comes to rest on the perch panels 58.

FIG. 3 shows a cross sectional view of an example of an electrically conductive tether 30. The electrically conductive tether 30 may be constructed of a carbon fiber core 34 surrounded by aluminum conductors 36. The carbon fiber core 34 and aluminum conductors 36 may be positioned within an outer insulation 38. As noted above, the tether 30 transmits electricity from the aerial vehicle 20 to the ground station 50 through the aluminum conductors 36, and care must be taken to protect the tether 30 as it is wrapped onto the drum. In an embodiment, the tether 30 has a length of 500 meters, which must be carefully wound onto the drum, without crushing or damaging the tether 30. The tether 30 tends to be very strong in tension, but fragile in storage as the insulation 38 and aluminium conductors 36 can be compressed. In an example embodiment, the diameter of the carbon fiber core 34 is 14 millimeters and the diameter of the tether is 24 millimeters.

B. Illustrative Components of a Drum and Levelwind

FIG. 4 illustrates example components of a ground station 50 including a drum 52 and levelwind 55. The drum 52 has a grooved surface to receive and protect the tether 30, and the drum groove ascends the drum's surface as a helix with a constant pitch. The levelwind 55 includes a central guide groove that may keep the tether 30 aligned with the helical groove about the drum 52. As the example drum 52 rotates, the tether 30 may be wound into the helical groove and each successive wrap of the tether 30 will be spaced an equal distance apart. The wrapped tether 30 may slowly descend the surface of the drum 52 as the drum 52 it rotates.

Similarly, the levelwind 55 may also descend adjacent to the drum 52 at the same rate, such that it remains in alignment with the desired groove location on the drum surface. For instance, if the pitch of the helical groove descends 25 millimeters per rotation of the drum 52, the levelwind 55 may also descend 25 millimeters per rotation of the drum. To accomplish this, the levelwind 55 may be mechanically coupled to a linear actuator. Further, because the linear movement of the levelwind 55 may be directly correlated to the rotation of the drum 52, the linear actuator which controls the position of the levelwind 55 may be geared to the same motor that rotates the drum 52.

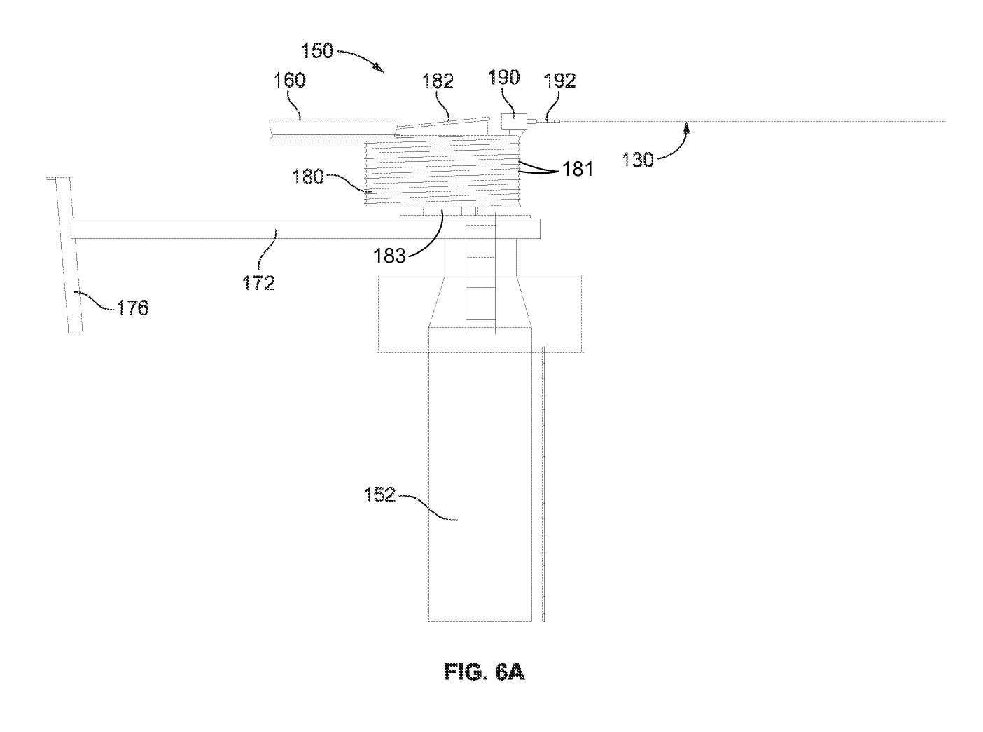

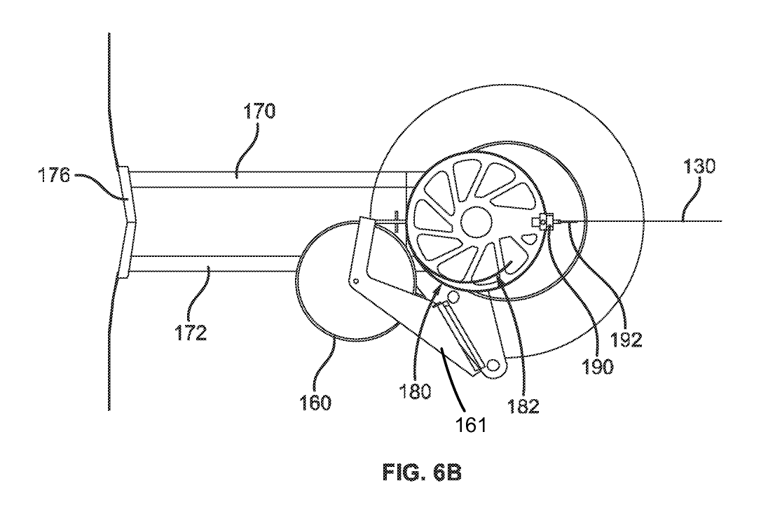

However, in some embodiments, the groove in the drum surface may not have a constant pitch. Rather, the pitch of the helical groove may be varied in order to increase the spacing between wraps of the tether. In some cases, this may be desired to avoid conflicts with other components of the system. FIGS. 6A and 6B illustrate a side view and a top view a of an example ground station 150, including a modified drum 180, a levelwind 160, and a ground-side-gimbal (GSG) 190 according to an example embodiment. In FIGS. 6A and 6B, the tether 130 is fully unwound, and the aerial vehicle (not shown) may be in cross-wind flight. The example ground station 150 may also include a tower 152 upon which the drum 180 is positioned. The tower may be, for example 15 meters in height. A perch panel 176 is supported by perch panel support members 170, 172 that extend horizontally from the ground station 150. The perch support members 170, 172 may rotate about the top of the tower 152 so that the perch panel 176 is in the proper position when the aerial vehicle 120 is landing. In FIGS. 6A and 6B, the perch support members 170, 172 are rotate to the opposite side of the GSG 190 during cross-wind flight.

The GSG 190 may allow for changes in pitch, roll, and yaw of the tether 130 during cross-wind flight and thereby minimize bending and torsional forces on the tether 130 at its connection point to the ground station 150. The GSG 190 may include a spindle 192 at the connection point of the tether 130 that constrains any bending for a portion of the tether 130. The spindle 192 may provide increased leverage for the tether 130 to more easily rotate the GSG 190, reducing stresses on the tether 130. The GSG 190 may be fairly large, and it may be located above the top edge of the drum 180, near its perimeter. Further, because the GSG 190 rotates in the tether's azimuth direction, it may rotate to one side and “lay over” when the drum 180 begins to wind in the tether 130.

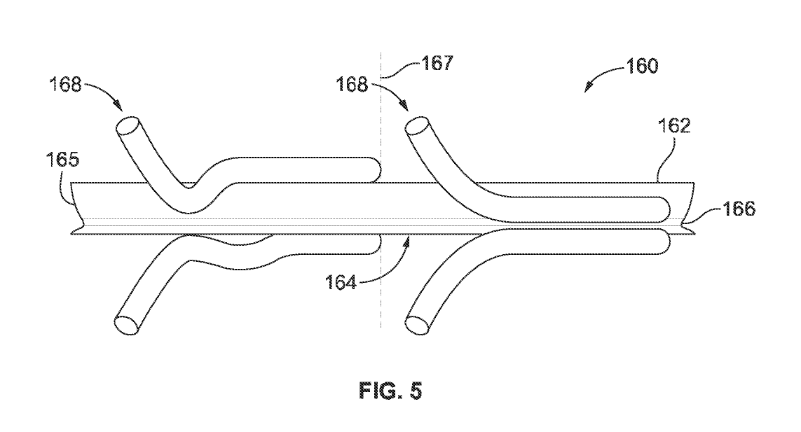

FIGS. 6A and 6B also show a levelwind 160 according to an example embodiment, which is described in more detail below with respect to FIG. 5. Similar to the perch support members 170, 172, a supporting arm 161 (not shown in FIG. 6A for clarity) for the levelwind 160 may rotate the levelwind 160 about the drum 180 to position the levelwind 160 on the opposite side of the drum 180, away from the GSG 190 during cross-wind flight. Other positions for both the perch support members 170, 172 and the levelwind 160 during cross-wind flight are also possible.

As a result of the size, location, and configuration of the GSG 190, a convergence issue may result when winding the tether 130. For instance, if the ground station 150 shown in FIGS. 6A and 6B utilized a drum such as the drum 52 shown in FIG. 4, the surface of the drum 52 may not extend all the way up to the tether's origination point at the spindle 192. The GSG 190 may be too large, and its position near the perimeter of the drum 52 may prevent the vertical extension of the drum 52. Further, even if a section of the drum 52 could be extended, wrapping the tether 130 at a desired pitch for the helical drum groove of, for example, 25 millimeters per rotation of the drum 52, may result in the second wrap of the tether 130 conflicting with the GSG 190. The GSG 190 may simply be too large, and get in the way of the tether 130 if it is wrapped about the drum at a pitch of only 25 millimeters per rotation. Increasing the pitch of the helical groove and the spacing of the tether 130 across the entire drum 52 may be inefficient, and result in a drum 52 that is excessively large. Also, the end of the spindle 192, where the tether 130 may begin wrapping about the drum 52, may not be tangent to the drum surface when the GSG 190 lays over.

Therefore, in some embodiments, the geometry of the drum surface may be modified. In FIGS. 6A and 6B, the drum 180 may include a drum section 182, consisting of approximately the first three-quarters of a rotation from the top of the drum 180. The drum section 182 may be raised, and may include a helical groove 181 having a pitch that is increased from a typical pitch of 25 millimeters per rotation to 250 millimeters per rotation. Other values for the pitch of the drum groove 181 are also possible. This may allow the tether 130 to be wound further down on the drum 180, away from the GSG 190, for the first drum rotation. Thereafter, on the second and subsequent rotations of the drum 180, the helical drum groove 181 may have a constant pitch of 25 millimeters per rotation. Further, the raised drum section 182 may have a reduced radius as measured from the drum's rotational axis. As a result, the raised drum section 182 at the top of the drum 180 may spiral inward toward the tether's connection point at the spindle 192 when the GSG 190 is lying over, as further detailed below.

The symmetric levelwind 55 shown in FIG. 4 may be used with the modified drum 180 from FIGS. 6A and 6B. However, because the pitch of the helical groove 181 on the drum 180 is not constant for drum section 182, the symmetric levelwind 55 may not descend adjacent to the drum 180 at a constant rate in relation to the constant rotation of the drum 180. Rather, the levelwind 55 would have to move vertically a greater distance per rotation of the drum as the tether 130 is wound onto drum section 182, and then move vertically a lesser distance per rotation of the drum as the tether 130 is wound onto the remainder of the drum 180, where the pitch of the groove 181 remains constant. Accordingly, additional controls may be used to determine when the drum groove 181 is increasing in pitch and then a variable speed drive may increase the rate at which the levelwind 55 moves up and down adjacent to the drum 180. This deterministic approach may keep the levelwind 55, and thus the incoming tether 130, aligned with the drum groove 181, even though the groove 181 does not have a constant pitch.

Alternatively, a non-deterministic approach may be employed using a modified levelwind 160 as shown in FIGS. 6A and 6B. FIG. 5 shows a side view of the levelwind 160 according to an example embodiment. The levelwind 160 may have an asymmetric geometry to accommodate the increased pitch in the drum groove 181 at the beginning of the drum's rotation. The levelwind 160 may include a first edge 162 having a first diameter and a second edge 164 having a second diameter, with both edges concentric about a rotational axis 167 of the levelwind 160.

The levelwind 160 may also include a guiding surface 165 in between the two edges. The guiding surface 165 may include a guide groove 166 perpendicular to the rotational axis 167 and sized to receive the tether 130, however the guide groove 166 may not be centered in the guiding surface 165 of the levelwind 160. Instead, the perpendicular distance from the first edge 162 to the guide groove 166 may be greater than the perpendicular distance from the second edge 164 to the guide groove 166. This may allow the tether 130 to make contact with the levelwind 160 in this area of increased height on the guiding surface 165, between the first edge 162 and the guide groove 166. The guiding surface 165 of the levelwind 160 may bias the tether 130 downward as the levelwind 160 rotates, as further detailed below.

In some examples, the perpendicular distance from the first edge 162 of the levelwind 160 to the guide groove 166 may be at least 250 millimeters, any may approximately correspond to the increased height of the drum section 182. In some cases, this may be at least four times greater than the perpendicular distance from the second edge 164 to the guide groove 166. Other sizes are also possible. Further, in some examples, the diameters of the first edge 162 and the second edge 164 may be substantially the same. In other examples the diameter of the first edge 162 may be greater than the diameter of the second edge 164. Additionally, due to the size of tether 130, the drum 180, and other components of the ground station 150, the levelwind 160 may be rather large. In some examples, the guide groove 166 may have a third diameter that is at least 3 meters.

The levelwind 160 may also include at least one guidance structure positioned to bias the tether 130 toward the guide groove 166 of the levelwind 160. The guidance structure may include at least one rounded guide bar 168 as shown in FIG. 5. Ski-shaped guides, rolling bars, and other structures that may effectively guide the tether 130 toward the levelwind 160 without damaging the tether 130 are also possible.

Additionally, for the drum section 182 where the drum groove 181 has an increased pitch, the additional height of the drum section 182 between grooves may also be configured to bias the tether 130 into the drum groove 181. Therefore, as the pitch of the drum groove 181 increases, the area on which the levelwind 160 may place the tether 130 may also increase.

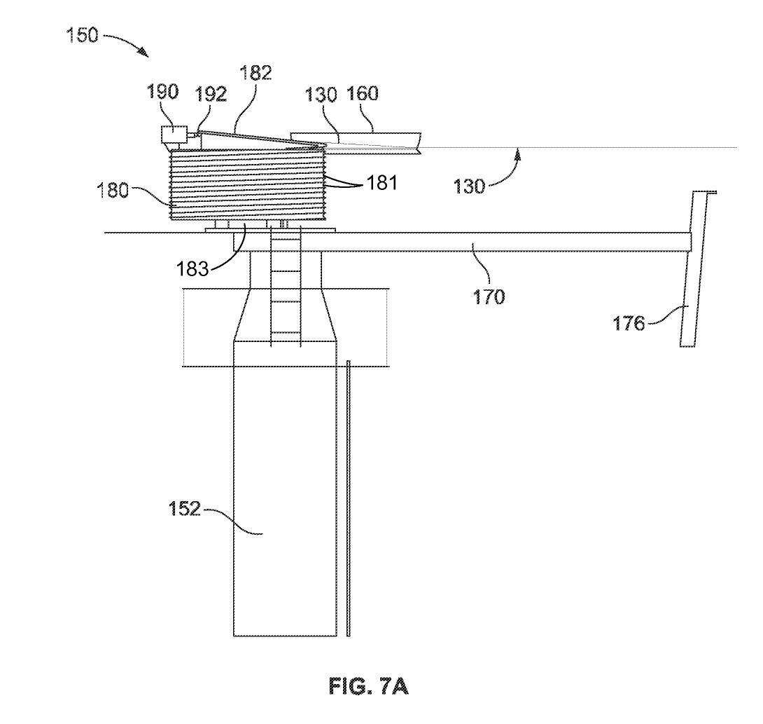

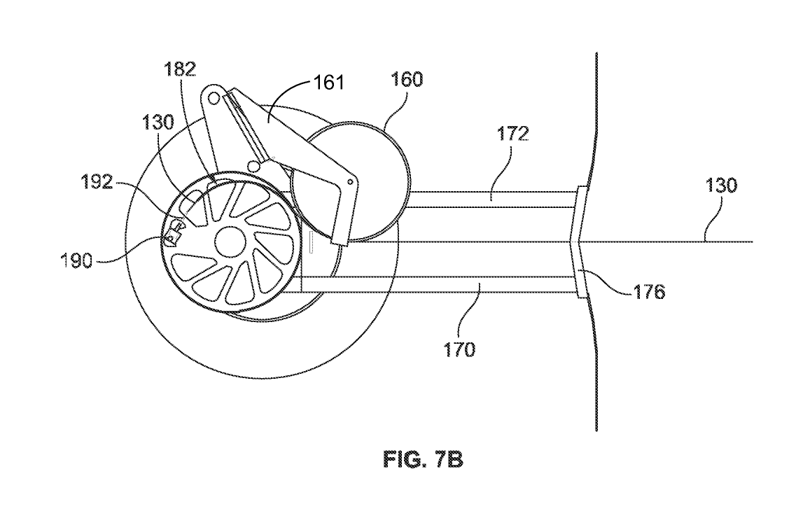

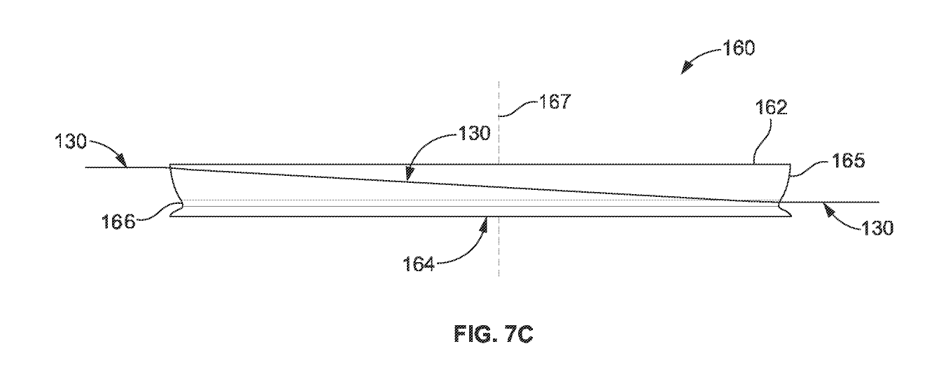

FIGS. 7A and 7B illustrate another side view and a top view of the example ground station 150. In FIGS. 7A and 7B, the aerial vehicle (not shown) may be in hover flight for landing. Both the levelwind 160 and the perch support members 170, 172 may be rotated to the side of the drum 180 from which the tether extends, the same side on which the aerial vehicle will land. In FIGS. 7A and 7B, the drum 180 has rotated counterclockwise from its orientation is FIGS. 6A and 6B. In doing so, the tension of the tether 130 on the spindle 192 may cause the GSG 190 to rotate clockwise with respect to the drum 180. As the drum 180 rotates counterclockwise and the GSG 190 lies over, the tether 130 may contact the levelwind 160 on the levelwind guiding surface 165. The tether 130 may then be placed onto the raised drum section 182, which may be tangent to the angle of the spindle 192 as the GSG 190 reaches its final “laid over” orientation shown in FIG. 7B.

As the drum 180 continues to rotate counterclockwise, the guiding surface 165 of the levelwind 160 may bias the incoming tether downward toward the levelwind guide groove 166. FIG. 7C shows a side view of the levelwind 160 as it guides the tether 130 onto the raised drum section 182. The tether 130 may not be positioned entirely within the levelwind guide groove 166. Instead, it may be only partially positioned therein, while the remainder of the contact between tether 130 and levelwind 160 occurs on the increased height of the guiding surface 165. In some examples, the levelwind 160 may passively rotate (clockwise, as shown in FIG. 7B) about its rotational axis 167 due to the friction resulting from contact with the tether 130. In other examples, the rotation of the levelwind 160 may be driven by a motor.

Additionally, on raised drum section 182 where the drum groove 181 has an increased pitch, the additional height between drum grooves may also be configured to bias the tether 130 into the drum groove 181. Therefore, as the pitch of the drum groove 181 increases, the area of the raised drum section 182 on which the levelwind 160 can place the tether 130 may also increase.

The embodiments shown in FIGS. 7A-7C may be referred to as non-deterministic winding, at least for the first three-quarters of a rotation the drum 180, where the tether 130 is first wound onto the raised drum section 182, because the tether 130 may not be transferred directly from the levelwind guide groove 166 to the drum groove 181. Instead, the levelwind 160 may receive the tether 130 anywhere within the increased height of the levelwind's guiding surface 165, and the levelwind 160 may then transfer the tether 130 onto the drum section 182 within the similarly increased height between drum grooves.

Because of the correspondence between the asymmetric configuration of the levelwind 160 and the raised drum section 182, a variable speed drive or additional controllers may not be needed to vary the rate at which the levelwind 160 ascends or descends adjacent to the rotating drum 180. In such embodiments, the drum 180 may be mechanically coupled to a motor 183 for rotating the drum 180 about its rotational axis. Further, the levelwind 160 may be positioned vertically on its own rotational axis by a linear actuator that is geared to the same motor 183 such that the levelwind is positioned at a constant rate with respect to the drum's rotation. Thus, the two movements may maintain a constant relationship throughout the tether winding process. The linear actuator may be a component of the supporting arm 161.

For example, the levelwind 160 may be positioned such that the guide groove 166 on the levelwind 160 remains in substantial alignment with the drum groove 181 for the majority of the drum's rotation where the drum groove 181 has a constant pitch. For the raised drum section 182, where the drum groove 181 has an increased pitch, the drum groove 181 and the levelwind guide groove 166 may not be aligned. However, the drum groove 181 may nonetheless remain in substantial alignment with the full height of the levelwind's guiding surface 165.

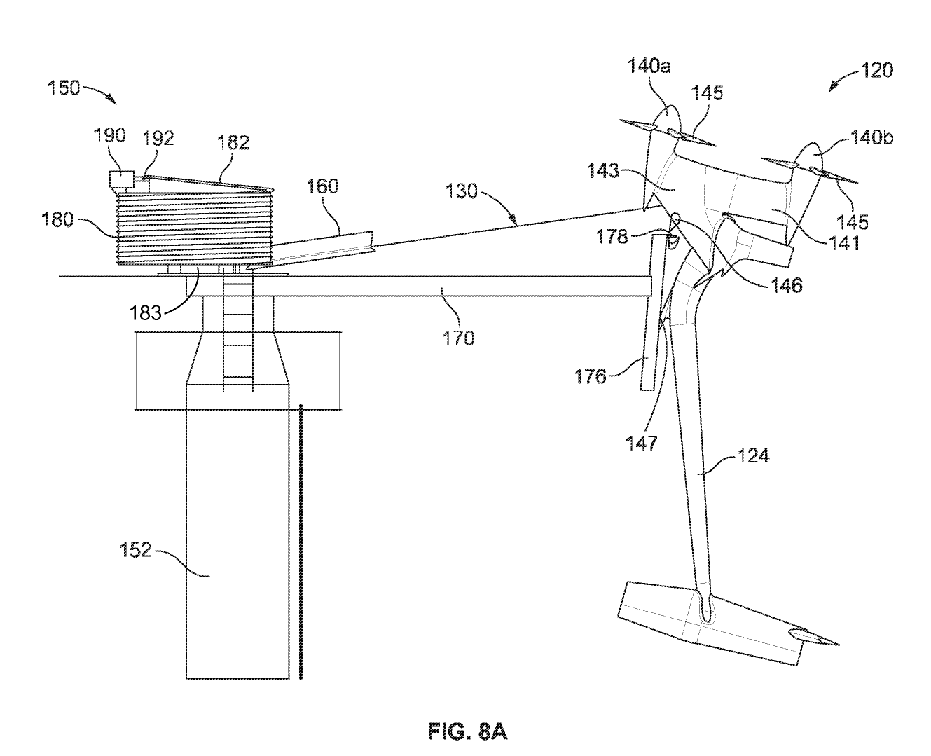

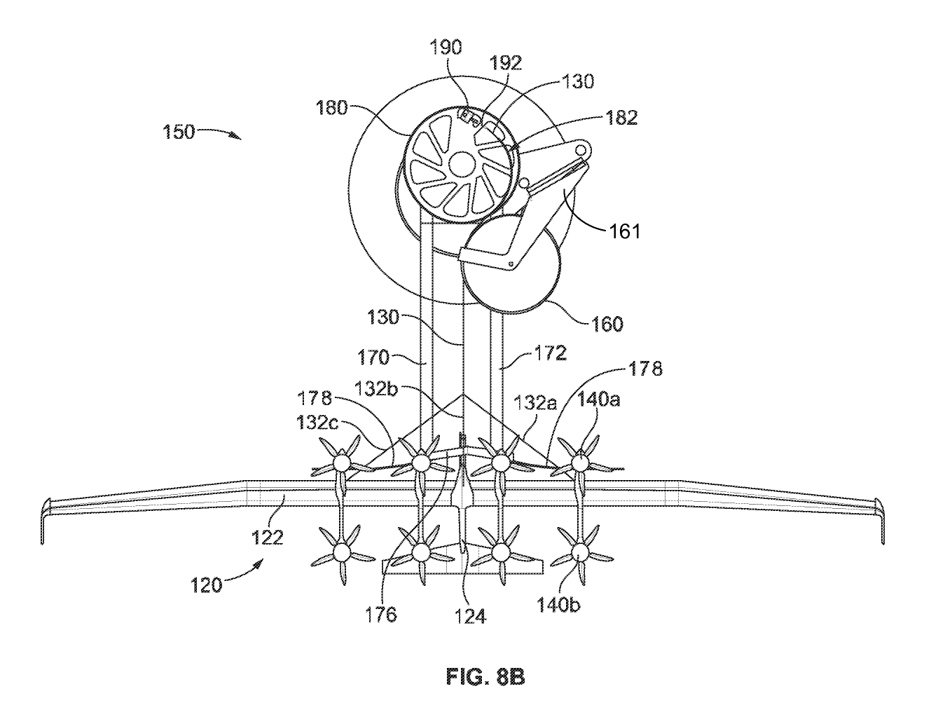

FIGS. 8A and 8B illustrate another side view and a top view of the example ground station 150. In FIGS. 8A and 8B, the aerial vehicle 120 has landed on the perch panel 176, and the tether 130 has been fully wound onto the drum 180. The tether 130 may be attached to the wing 122 of the aerial vehicle 120 using bridle lines 132a, 132b, and 132c. In some examples, the aerial vehicle 120 may rest on the perch panel 176 in such a way that its connection point to the tether 130 is not vertically aligned with the bottom of the drum 180. In such an example, the supporting arm 161 of the levelwind 160 may tilt the rotational axis 167 of the levelwind 160 as the levelwind 160 approaches the bottom of the drum 180, such that the levelwind 160 is substantially aligned with the tether 130 when the aerial vehicle 120 lands on the perch panel 176. In this condition, the levelwind 160 may be tilted such that the levelwind's guide groove 166 adjacent to the drum 180 may remain in alignment with the drum groove 181.

Aerial vehicle 120 includes lower rotors 140a mounted on pylons 143 attached to wing 122 and upper rotors 140b mounted on pylons 141 attached to the wing 122 having propellers 145. In an embodiment, the wing 122 is 4 meters long. Aerial vehicle 120 includes a fuselage 124 having a curved section to which a peg 147 is attached. A pair of hooks 146 may be attached to the main wing 122 and positioned on opposite sides of the peg 147. In a perched condition, as shown in FIGS. 8A and 8B, peg 147 may contact the perch panel 176, and the hooks 146 may contact a bar 178 that extends from both sides of the perch panel 176.

The example embodiments above have generally described the winding in of the tether 130 and the landing of the aerial vehicle 120. It should be readily understood that the same embodiments may be used in substantially the same way, although in reverse, for winding out the tether 130 as the aerial vehicle 120 ascends in hover flight.

### III. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A levelwind apparatus comprising:
a rotational axis;
a first edge having a first diameter;
a second edge having a second diameter, wherein the first and second edges are concentric about the rotational axis; and
a guiding surface located between the first and second edges, wherein the guiding surface comprises a guide groove perpendicular to the rotational axis and sized to receive a tether, wherein the perpendicular distance from the first edge to the guide groove is greater than the perpendicular distance from the second edge to the guide groove.

2. The apparatus of claim 1 wherein the perpendicular distance from the first edge of the levelwind to the guide groove is at least four times greater than the perpendicular distance from the second edge of the levelwind to the guide groove.

3. The apparatus of claim 1 further comprising at least one guidance structure positioned to bias the tether toward the guide groove of the levelwind.

4. The apparatus of claim 1 wherein the first diameter and the second diameter of the levelwind are substantially the same.

5. The apparatus of claim 1 wherein the guide groove has a third diameter, wherein the third diameter is at least 3 meters.

6. A system comprising:
a drum comprising:
a first rotational axis; and
a substantially cylindrical drum surface, wherein the drum surface comprises a helical groove sized to receive a tether, the helical groove having a pitch relative to the first rotational axis, wherein the pitch of the helical groove varies about the drum surface;
a motor mechanically coupled to the drum for rotating the drum about the first rotational axis;
a levelwind comprising:
a second rotational axis;
a first edge having a first diameter;
a second edge having a second diameter, wherein the first and second edges are concentric about the second rotational axis; and
a guiding surface located between the first and second edges, wherein the guiding surface comprises a guide groove perpendicular to the second rotational axis and sized to receive a tether, wherein the perpendicular distance from the first edge to the guide groove is greater than the perpendicular distance from the second edge to the guide groove; and
a linear actuator mechanically coupled to the motor and configured to position the levelwind along the second rotational axis such that the guiding surface remains in substantial alignment with the helical groove on the drum surface as the drum rotates about the first rotational axis.

7. The system of claim 6 wherein the linear actuator is mechanically coupled to the motor for rotating the drum such that the levelwind is positioned along the second rotational axis at a constant rate with respect to the rotation of the drum.

8. The system of claim 6 wherein the pitch of the helical groove varies between 25 millimeters per rotation of the drum surface and 250 millimeters per rotation of the drum surface.

9. The system of claim 6 wherein the drum further comprises a drum height, wherein the drum surface comprises a radius measured from the first rotational axis, and wherein the radius of the drum surface varies along the drum height.

10. The system of claim 6 wherein the perpendicular distance from the first edge of the levelwind to the guide groove is at least four times greater than the perpendicular distance from the second edge of the levelwind to the guide groove.

11. The system of claim 6 wherein the perpendicular distance from the first edge of the levelwind to the guide groove is at least 250 millimeters.

12. The system of claim 6 wherein the first diameter and the second diameter of the levelwind are substantially the same.

13. The system of claim 6 wherein the guide groove has a third diameter, wherein the third diameter is at least 3 meters.

14. The system of claim 6 wherein the linear actuator comprises a lead screw mechanically coupled to the motor.

15. The system of claim 6 further comprising at least one guidance structure positioned to bias the tether toward the guide groove of the levelwind.

16. The system of claim 15 wherein the guidance structure includes at least one rounded guide bar.

17. A method of winding a tether about a drum comprising:
rotating the drum about a first rotational axis, wherein the drum comprises:
the first rotational axis; and
a substantially cylindrical drum surface, wherein the drum surface comprises a helical groove sized to receive a tether, the helical groove having a pitch relative to the first rotational axis, wherein the pitch of the helical groove varies about the drum surface; and
positioning a levelwind having a guiding surface along a second rotational axis at a constant rate with respect to the rotation of the drum such that the guiding surface remains in substantial alignment with the helical groove on the drum surface as the drum rotates about the first rotational axis, and wherein the levelwind comprises:
the second rotational axis;
a first edge having a first diameter;
a second edge having a second diameter, wherein the first and second edges are concentric about the second rotational axis; and
the guiding surface located between the first and second edges, wherein the guiding surface comprises a guide groove perpendicular to the second rotational axis and sized to receive a tether, wherein the perpendicular distance from the first edge to the guide groove is greater than the perpendicular distance from the second edge to the guide groove.

18. The method of claim 17 further comprising the step of biasing the tether toward the guide groove using at least one guidance structure.

19. The method of claim 17 wherein the drum is rotated about the first rotational axis by a motor mechanically coupled to the drum.

20. The method of claim 19 wherein the levelwind is positioned along the second rotational axis using a linear actuator, wherein the linear actuator is mechanically coupled to the motor.
